(19) United States
(12) Patent Application Publication
(10) Pub. No.: US 2007/0261997 A1
(43) Pub. Date: Nov. 15, 2007

(54) Automated dry cleaning assembly conveyor system

(75) Inventors: Tony L. Cassady, Rindge, NH (US); William T. Epperson, Little Rock, AR (US)

Correspondence Address: Stephen D. Carver, Suite 800, 2024 Arkansas Valley Drive, Little Rock, AR, 72212-4147, US

(73) Assignee: HMC Solutions, LLC, d/b/a HMC Solutions

(21) Appl. No.: 11/801,728

(22) Filed: May 10, 2007

Related U.S. Application Data
(60) Provisional application No. 60/799,518, filed on May 11, 2006.

(51) Int. Cl. B07C 5/02; G06F 7/00; B03C 1/00; B07C 5/00; G06K 9/00

(52) U.S. Cl. 209/3.3; 209/583; 700/215; 209/221; 209/224

(57) ABSTRACT

An automated assembly conveyor method and apparatus for dry-cleaners recognizes, associates, and consolidates garments in customer transactions by reading garment identification tags. A scanning apparatus whose construction may vary depending upon they type of garment tagging system utilized by a given retail drycleaner reads tags through Optical Character Recognition (OCR) scanning, Bar Code scanning, or Radio Frequency (RF) means, and manual error correcting input is also facilitated. A large inventory of garments assembled into unique orders by customer., each “group” having at least one garment. The software collects information relating to “promised day,” “piece count”, “tag color” “striped or non-striped”, and “tag style” for operator display.

### CROSS-REFERENCE TO RELATED APPLICATION

This application is based upon, and claims the priority filing date, of the previously-filed, copending U.S. Provisional patent application entitled “AUTOMATED DRY CLEANING ASSEMBLY CONVEYOR SYSTEM,” filed May 11, 2006, Ser. No. 60/799,518.

### BACKGROUND OF THE INVENTION

I. Field of the Invention

The present invention relates generally to automated sorting and conveyor apparatus used in retail dry cleaning establishments. More particularly, the present invention relates to automatic, dry cleaning sorting systems that read and respond to product bar codes, various labels, and RF tags for the subsequent computerized classification and sorting of the goods.

II. Description of the Prior Art

A compelling burden in the dry-cleaning industry is to classify and account for the many garments and products moving through the cleaning apparatus. Many dry-cleaning establishments use antiquated, non-computerized, manual techniques for sorting products. Older sorting routines can be extremely cumbersome and time consuming, besides being error prone. Typically, to keep track of orders, dry-cleaning establishments may divide garments or groups of customer garments into unique customer orders.

After products are cleaned, an assembly process follows. During assembly, cleaned garments are gathered and returned to the customer. The process requires the proper evaluation of order numbers for each garment.

A basic function of inventory control is the counting of incoming and outgoing materials, and the keeping of a running total. In some situations, the identity of specific articles must be monitored, making inventory control somewhat more complicated. Automation in marking, sensing and routing can present enormous cost savings over manual operations for such establishments. Although the user is always subject to equipment failure, every step at which manual functioning and decision making can be eliminated likewise avoids time loss, errors, and various losses associated with human operation.

An inventory control system particularly adapted for a dry-cleaning store has many needs in common with the usual merchandise distribution warehouse system. Furthermore, the relatively low cost of individual transactions and cleaning operations aggravates the need to cut costs. In general, the possible revenue to be gained by processing a single article is quite small in comparison to the possible dissatisfaction which could be generated with consumers by even small percentage losses of articles and the like.

The usefulness of automated apparatus for information and process control has further benefits. The optimization of dry-cleaning store efficiency requires that garments or products be divided into batches of similar characteristics that may be processed as units. For example, all articles of a given type of fabric may be best processed under certain conditions involving specific cleaning fluids, particular operating temperatures and timing cycles, and the like. The operator (or his supplier) can clean the largest number of articles at the least expense by most efficiently allocating his machines and materials to reflect the particular mix of supplies being presented by the customers.

Various systems of lot accumulation, inventory reporting and other such inventory control and operation systems are known in the art. For example, automated systems in which digital computers are employed for counting purposes are known in connection with laundry systems. An example of such a system is shown in U. S. Pat. No. 3,876,075. In the system described in the latter patent, customer identification and sorted article counts are computer processed to assist in the allocation of identifiable product lots to specific cleaning machines.

In connection with laundry systems, a common practice has been to apply a unique tag to a unit of laundry. While such tags may have alpha-numeric markings that are machine readable, it is preferable that the tags also be readable by the human operators. Once prepared, the identifying tags are coupled to the product or article of clothing. A different or more complicated indicia may also be attached to a hanger or the like, upon which the article of clothing is suspended. In any event, some form of code is needed for each article.

Bar codes applied to various forms of identification labels are increasingly popular for identifying products or packages. In typical retail establishments, dealing with diverse goods and merchandise, each product has a unique bar code number that identifies the product, its price, the manufacturer or source, and other commercial data. Bar codes are quickly read by laser scanning and then decoded by suitable bar code reader apparatus. Various computer programs are available for utilizing decoded indicia obtained from bar codes in a database. Images may also be captured during the scanning process. However, once an image is captured, it must be processed to identify and decode a variety of encoded indicia, including bar codes, two-dimensional dense codes, and alphanumeric characters.

Many drycleaners attach bar coded, machine readable identification labels to each garment. These bar coded tags may be permanently attached to the garment (using a “heat seal” type of tag), or the bar code may be printed on a “one time use” tag material and attached to the garment for each cleaning cycle.

While bar coded labels can be used in dry-cleaning establishments, the washing process to which items are subjected may degrade the printing, making it difficult and error prone to read and decipher. In some cases, the damage or degradation may be extensive enough that no amount of rescanning will be able to recover the lost information. Typical dry cleaning labels or tags include relatively large, human readable characters corresponding to the bar code characters that are printed adjacent to the bar code. When the bar code is unreadable, the human readable text may be deciphered by a human attendant, and data may be manually entered into the associated computer database.

RF or RFID identification chips and paper ID tags also find application in the retail dry-cleaning industry. Each identification method requires unique scanning techniques and hardware to read and interpret the encoded information. Radio Frequency (RF) chips are utilized by a small group of very large drycleaners to uniquely identify garments.

Most drycleaners continue to utilize disposable, single usage paper identification tags that are temporarily attached to each garment. These paper ID tags contain the alphanumeric identification information necessary to uniquely identify and relate each garment to its respective customer order.

Another data input option is the manual entry of the identification tag information by a human operator. This input method is old and time consuming, but a modern scanning system must offer this form of input as a substitute where the scanning system is unable to electronically read the information tag or process the scanned information derived therefrom. Where the scanning apparatus fails to function, data must be manually entered via a computer keyboard. As a practical matter modern scanning systems must provide for manual scanning as the last line of defense against unreadable tags to prevent the loss or mismatching of articles or garments.

U.S. Pat. No. 5,581,064 issued Dec. 3, 1996 discloses a system for reading popular retail discount coupons. Identifying information can be derived with a bar code reader, an OCR scanner, a combination bar code reader/OCR scanner, or manual entry. The manufacturer's discount coupon has an alphanumeric identification of a particular item, a description and an amount by which to decrease the retail price of the item, an expiration date, and a U.P.C. (Universal Product Code), or other code, that identifies it. The system correlates the first identifying code with one or more second identifying codes, and chooses a particular one of the second identifying codes in uniquely identifying the coupon.

U.S. Pat. No. 6,832,726 issued Dec. 21, 2004 provides barcode optical character recognition software configured to create a printer format based on scanned labels. After an existing label is scanned, the software converts the scan into a label format through optical character recognition (OCR). The software recognizes and distinguishes text, graphics, and barcodes.

U.S. Pat. No. 5,880,451 issued Mar. 9, 1999 discloses an OCR processing system that reads human readable characters corresponding to an unsuccessfully decoded word in a bar code symbol. An imaging system captures an image of the label including its bar code symbol and corresponding human readable characters. If a bar code character is not successfully decoded, the system locates the associated human readable text and segments the text into individual character images. The unsuccessfully decoded bar code character is mapped to one or more of the alphanumeric character images, which are converted into text characters. The resulting ASCII data is used to create a substitute bar code character in the bar code symbology.

U.S. Pat. No. 6,744,938 issued Jun. 1, 2004 discloses a retail terminal with an imaging scanner that scans and reads labels to derive identifying product attributes. An attribute recognition program such as an optical character recognition (OCR) program is used on the scanned product label that generates text strings from alphanumeric label information and graphics images from graphics and logos. Text strings and/or graphics data are then compared to various text strings and graphics data in a database or look-up table to return information relative to the scan. Data, stored either locally or at a remote site accessible via a network or the like, is correlated to a plurality of text strings/graphics that correspond to alphanumeric text/graphics on a plurality of product labels.

U.S. Pat. No. 5,770,841 issued Jun. 23, 1998 discloses a scanner including an imaging system and a label decoding system. The imaging system captures an image of a package surface that includes a machine readable code such as a bar code and an alphanumeric destination address. The label decoding system locates and decodes the machine readable code and uses OCR techniques to read the destination address. The destination address is validated by comparing the decoded address to a database of valid addresses. If the decoded address is invalid, an image of the destination address is displayed on a workstation and an operator enters the correct address. The system forms a unified package record by combining the decoded bar code data and the correct destination address data. The unified package record is used for subsequently sorting and tracking the package and is stored in a database and applied to a label that is affixed to the package.

U.S. Pat. No. 4,550,246 issued Oct. 29, 1985 discloses an inventory control and reporting system for dry-cleaning establishments. A data input keyboard provides information for analyzing processing costs of laundry articles, a data processor adapted to calculate pricing information and to generate reports based upon such data. Sequential bar code records and tags for attachment to the laundry articles are generated in sequential transactions. The bar code tags are attached to articles of clothing and are used with scanning apparatus to facilitate generation of reports according to various management needs.

U.S. Pat. No. 5,962,834 issued Oct. 5, 1999 discloses a tracking and management system designed especially for dry-cleaning inventory control using RF encoding device and optical encoding. The optical pattern includes a barcode for automatic or semiautomatic data capture as well as human readable characters that are cross referenced to the RF identifying code and to inventory control records in a database. An identification packet is attached to each garment for tracking.

### SUMMARY OF THE INVENTION

This invention provides an automated assembly conveyor method and apparatus that is especially designed for retail dry-cleaning and laundry applications. The preferred apparatus recognizes, associates, and consolidates dry-cleaned or laundered garments for customer transactions by reading garment identification tags attached to each garment by the retail drycleaner. The invention interfaces to a “Point of Sale” system when available.

Identification tags are read by a scanning apparatus whose construction may vary depending upon they type of garment tagging system utilized by a given retail drycleaner. The invention reads through Optical Character Recognition (OCR) scanning, Bar Code scanning, or Radio Frequency (RF) means.

The system easily assembles a large inventory of individual garments into unique groupings (sometimes referred to as “Orders”, or “Tickets”, or “Invoices”) by customer. The system efficiently manages the processes of scanning, identifying, and grouping individual garments into smaller groupings (called “Orders”) for each customer. Each different “group” has at least one garment, and may include a large number of garments. The system also maintains a running record of the inventory of customer Orders that are not completed and remain on the assembly conveyor for various reasons and may require special attention to resolve.

One component of the invention is a customized attribute recognition program (such as an OCR recognition program, or a bar code recognition program) which interprets the scanned garment identification tag(s) information and in turn generates an internal binary text string from this alphanumeric tag information. These internal binary text strings are then programmatically compared to various text strings stored in an inventory management system (e.g., existing point-of-sale system) database, or are compared to various text strings stored in an internal lookup table unique to the invention where an inventory management system is not present. This comparison process programmatically determines the identity of the customer “owner” of each garment. Also, this comparison process determines the identification number (also referred to as the customer Order Number) assigned to the “grouping” of garments in which this garment is assigned. This Order Number information, as well as the garment identification tag data is required for the re-assembly process. Once the Order Number associated with this garment identification tag is identified, the invention assigns a specific numbered location on a conveyor where all subsequent garments for this Order Number will also be grouped. As each garment is scanned, the invention identifies the Order Number associated with this garment and the invention automatically rotates a conveyor to the assigned location where all garments for the same Order Number will be consolidated. Once all garments for a specific Order Number have been consolidated, then the system notifies the operator that all expected garments for this Order Number have been processed and the “group” of garments for this Order Number are now ready for removal from the conveyor to be routed to the next stage in the plant production process (which is normally the “bagging station”).

The invention communicates with a Point-of-Sale System in use at the dry-cleaning plant over a computer network (either LAN or WAN). The order and garment in formation is received by the invention and stored in a local lookup table for retrieval and comparison when required at a later time. This local lookup table allows the system to continue to operate for several hours in the event the computer network fails. The invention also provides information about the garment's assembly status and operator efficiency information to the Point-of-Sale system using the same computer network and shared files. In the event that the Point-of-Sale system ceases to provide the information required to assemble the garments, the operator is notified by a flashing icon on the computer interface screen.

Thus a basic object is to provide a computerized system for automatically sorting, marking, and assembling various objects or items or groups of such items.

A related object is to provide an automatic reading and sorting system of the character described that is ideal for dry-cleaning establishments.

A fundamental object is to automate the process of manually matching dry-cleaning garment tags with the correct customers and/or the correct order numbers.

It is also an object of the invention to provide an automated inventory control system that addresses the particular needs of a retail dry-cleaning establishment.

A further object of the invention to use scanned bar code labels in a dry-cleaning establishment.

Another object of the invention to provide an inventory tracking and management apparatus in which identification codes for articles such as garments or orders of several garments can be acquired automatically for managing inventory.

Yet another important object of the invention is to provide an inventory scanning and tracking system that can use RF/RFID technology, bar code scanning technology, OCR technology, combined with the ability to accept and process manual data entry.

Another object of our invention is to employ a bar code scanner to electronically interpret identifying information encoded in a bar code associated with a tag applied to incoming goods to be laundered, and to use this garment identification information to complete the assembly process for each garment.

Another object is to provide a scanning system of the character described that utilizes OCR imaging scanner technology and an associated OCR interpretation program customized for the specific ID tag utilized by the drycleaner.

It is a further object of the invention to provide an inventory tracking and management system which employs RF encoding.

It is also an object to analyze optical character recognition (OCR) data in addition to bar code reading and scanning.

A related object of the present invention is to supplement bar codes with human readable characters or indicia.

A still further object is to verify, interpret, route and store decoded data associated with garment identification in a dry-cleaning establishment.

An object of the invention is to communicate with a Point-of-Sale System in use at the dry-cleaning plant over a computer network (either LAN or WAN). It is a feature of the invention that order and garment in formation is received by the invention and stored in a local lookup table for retrieval and comparison when required at a later time.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a partially exploded, fragmentary isometric view of the operator station according to the best mode of our invention;

FIG. 2 is a block diagram of the preferred system;

FIG. 3 is a block diagram of the conveyor control component of the present invention;

FIG. 4 is a diagrammatic view of the conveyor and operator station floor plan according to the best mode of the invention;

FIG. 5 is a fragmentary, isometric view of the OCR Scanner station;

FIGS. 6-8 are diagrammatic views of several sample garment identification tags readable by the invention;

FIG. 9-15 are flow diagrams of the computer software used for scanning garment identification tag information and for subsequent processing; and,

FIG. 16 is a flow diagram of the preferred software used for interfacing to a Point of Sale system.

### DETAILED DESCRIPTION

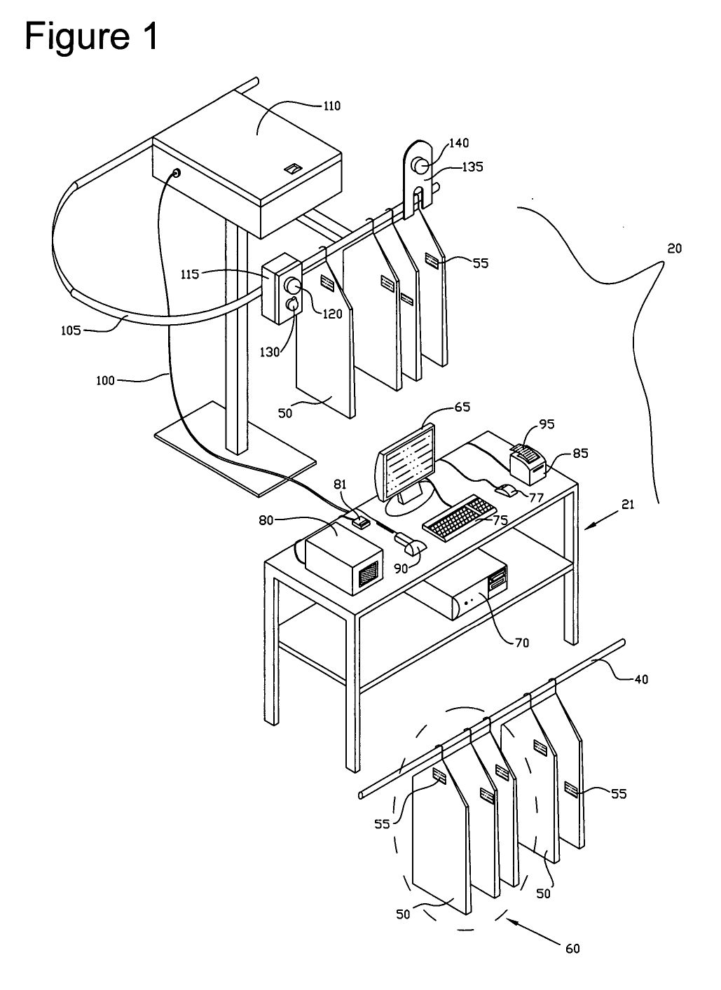

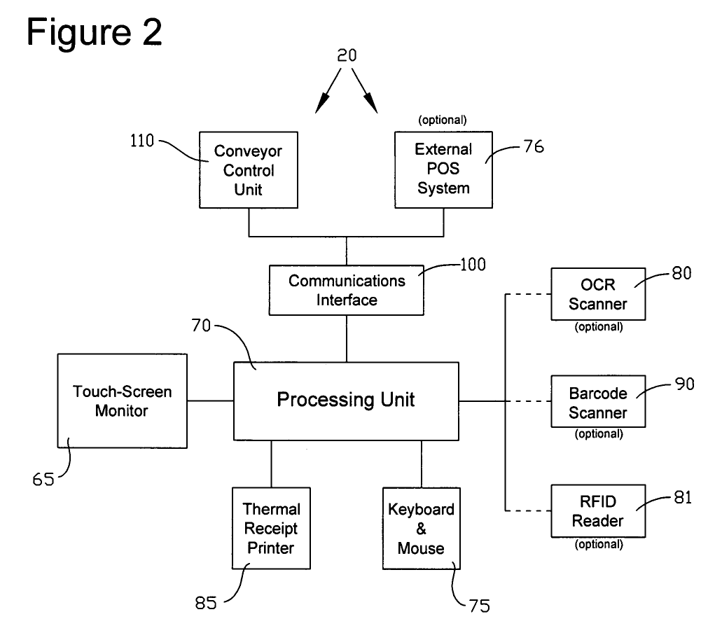

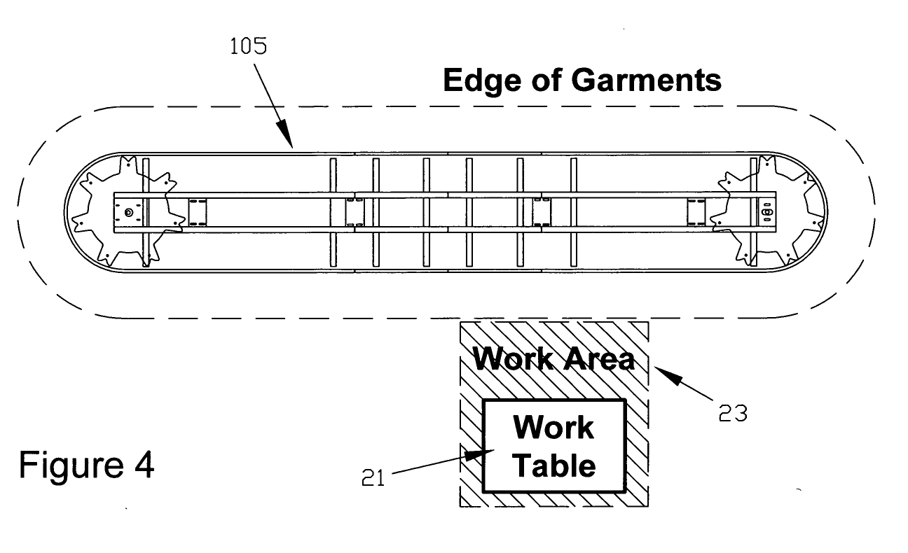

The invention comprises an automated dry-cleaning system 20 seen pictorially in FIG. 1 and in block form in FIG. 2. The system is adapted to handle and inventory items being dry-cleaned. As used herein, the term “item” designates not only garments, but other products such as, rugs, bedding items, pillow casings, blankets, and a variety of other things which can be dry-cleaned. An operator (not shown) usually stands near the work table 21 (FIG. 4) in the reception area 23 of a retail garment dry-cleaning establishment. In the “mark-in process,” one or more items, usually comprising garments 50, from a given customer during a given transaction are received. Group 60 (also called “customer orders)” of items belonging to a given customer transaction are identified. (If the same customer later brings more clothes or items for cleaning, a separate transaction is observed, and a separate customer order or group is formed.)

After a group is determined, its members become commingled with other items and other garments belonging to different customers that have been similarly associated with different orders. After cleaning is complete, system 20 aids the operator in reassembling the required garments 50 with the original group 60 (i.e., customer Order) that was determined immediately after the customer dropped off the garments for cleaning. The operator selects a garment 50 from the pre-assembly holding rail 40 and scans the attached garment ID tag 55 using either the OCR scanner 80 or a bar code scanner 90. Optionally an RF/RFID receiver 81 can be used. If for some reason information a garment ID tag 55 cannot be read by the scanner (or other equipment), the garment tag information can be manually entered using keystrokes via a computer keyboard 75 or mouse 77 (FIG. 1), or via a touch screen monitor 65 (FIGS. 1, 2). An external POS (i.e., “point-of-sale”) system is identified by the reference numeral 76 (FIG. 2)

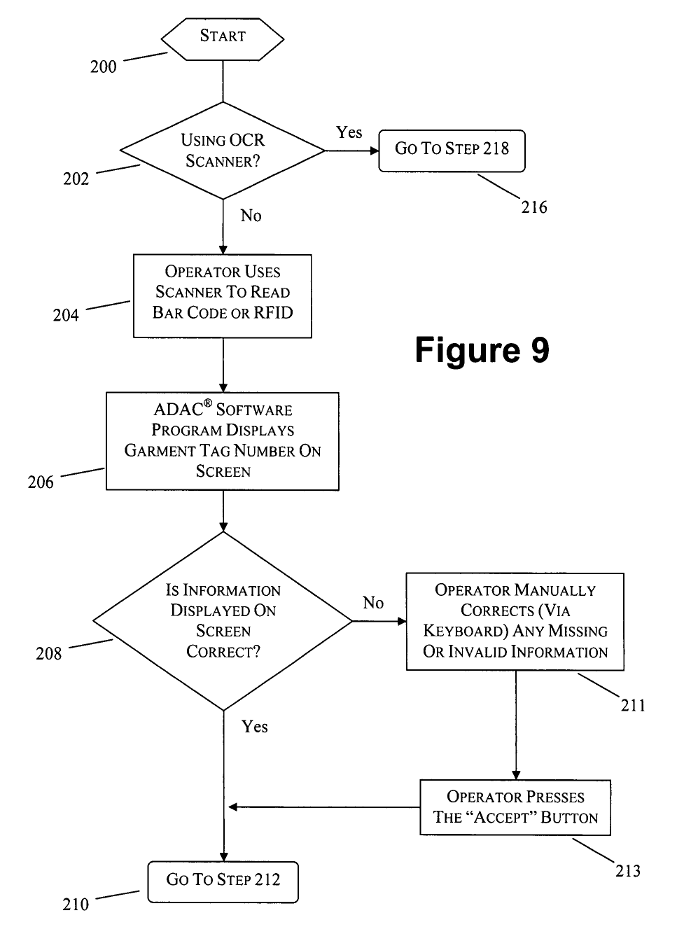

Once information from the garment ID tag 55 is received by the custom software program (i.e., FIGS. 9-15) running in the data processor 70, the invention programmatically assigns a specific slot number on the assembly conveyor 105 (FIG. 1) to be reserved for all garments associated with this same customer Order 60. The system then sends an electronic command from the data processor 70 (FIG. 2) via a communications interface 100 to the conveyor control panel 110 (FIGS. 1-3), causing the assembly conveyor 105 (FIG. 1) to automatically rotate until the reserved slot location on the conveyor is positioned at the loading shroud 135. The operator will now hang the garment 50 on this specified slot. The invention automatically detects that the operator has hung the garment 50 on the slot. Then the process is repeated with the next garment 50 to be assembled.

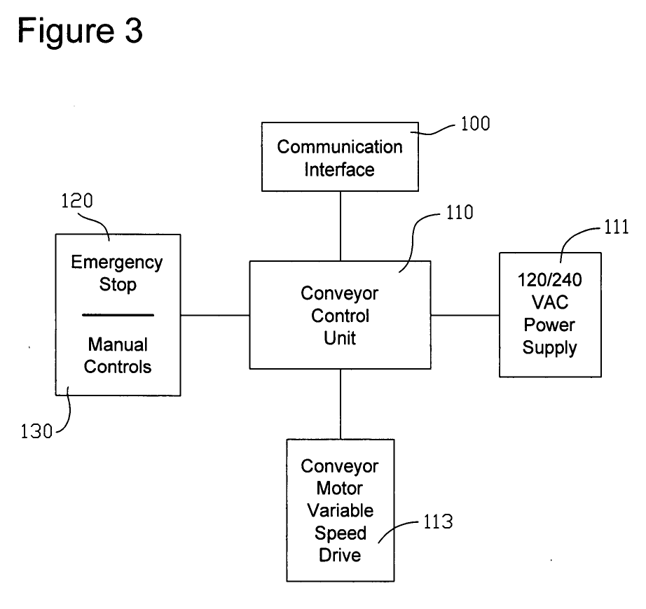

Power is supplied via source 111 (FIG. 3). The conveyor slots are programmatically assigned and tracked by the custom software to be described hereinafter. Preferred conveyors with the slot function are available from Iowa Techniques, Inc. 524 Tradesman Park Dr., Hutto, Tex. 78634.

One component of the invention is a customized attribute recognition program (such as an OCR recognition program, or a bar code recognition program) which interprets the scanned garment identification tag(s) information and in turn generates an internal binary text string from this alphanumeric tag information. These internal binary text strings are then programmatically compared to various text strings stored in an inventory management system (e.g., existing point-of-sale system) database, or are compared to various text strings stored in an internal lookup table unique to the invention where an inventory management system is not present. This comparison process programmatically determines the identity of the customer “owner” of each garment. Also, this comparison process determines the identification number (also referred to as the customer Order Number) assigned to the “grouping” of garments in which this garment is assigned. This Order Number information, as well as the garment identification tag data is required for the re-assembly process. Once the Order Number associated with this garment identification tag is identified, the invention assigns a specific numbered location on a conveyor where all subsequent garments for this Order Number will also be grouped. As each garment is scanned, the invention identifies the Order Number associated with this garment and the invention automatically rotates a conveyor to the assigned location where all garments for the same Order Number will be consolidated. Once all garments for a specific Order Number have been consolidated, then the invention will notify the Operator that all expected garments for this Order Number have been processed and the “group” of garments for this Order Number are now ready for removal from the conveyor to be routed to the next stage in the plant production process (which is normally the “bagging station”).

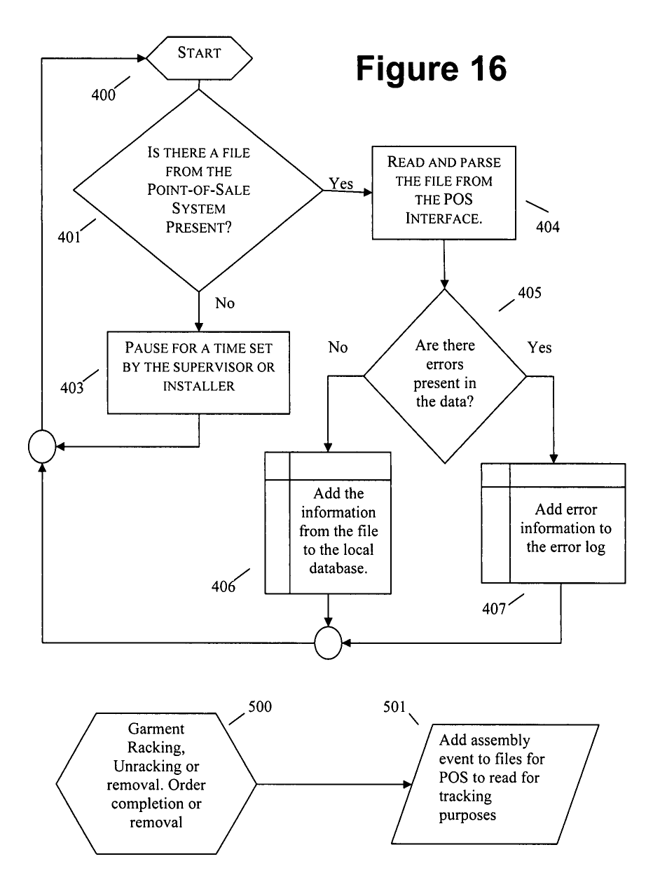

The invention communicates with a Point-of-Sale System via several commands issued using shared files over a computer network (either LAN or WAN) (FIG. 16). The Point-of-Sale System creates or appends to files with garment and order information. The order and garment information is read by the invention and stored in a local lookup table for retrieval and comparison when needed at a later time. This local lookup table allows the system to continue to operate for several hours in the event the computer network fails. The invention also provides information about the garment's assembly status and operator efficiency information to the Point-of-Sale system using the same computer network and shared files. Multiple files are used for different commands and information.

In the event that the Point-of-Sale system ceases to provide the information required to assemble the garments, the operator is notified by a flashing icon on the computer interface screen.

The series of files and the content was developed specifically for the invention by the inventors. This flexible format allows the invention to interface with multiple Point-of-Sale systems without modification to the original source code of the program. In the event that the data in the files are incorrectly formed or corrupted, the invention creates a log of the incorrect. This log is available to the operator for troubleshooting purposes

The speed of the conveyor can be varied as indicated by control 113 (FIG. 3).

Upon scanning the last garment 50 of a specific group 60 (customer Order), a receipt printer 85 (FIGS. 1, 2) produces a printed receipt 95 (FIG. 1) for the Completed Order, listing specific information related to each garment in the customer Order.

After automatic rotation of the conveyor 105 until the slot assigned for this customer order is positioned at the load shroud 135, a light 140 is illuminated over the loading shroud 135 as a visual confirmation to the operator that customer order 60 is complete and ready to be removed from the assembly conveyor 105. Sensor 145 located on the loading shroud 135 sends an electronic signal via a connecting cable to the data processor 70 (FIG. 2) to acknowledge that the customer order 60 has been removed from the conveyor. Once the garments 50 for the customer order 60 are removed from the assembly conveyor 105, this conveyor slot is now available to be re-assigned for another customer order.

The invention can operate with or without the presence of an inventory management control system (commonly referred to as a point-of-sale POS system). In the case where a POS system is not present, then the total number of garments 50 associated with a customer Order 60 would need to be present on the garment ID tag 55.

The scannable garment ID tag 55 information has been discussed with respect to optically scannable medium, such as a bar code or pre-printed paper garment lot control tags. Other optically scannable indicia can be used as well, as can electrically encoded scannable indicia such as RF chips or magnetically encoded tags. Alternatively, a less sophisticated encoding is possible, such as coding shown alphanumerically and entered by keystrokes via a computer keyboard 75.

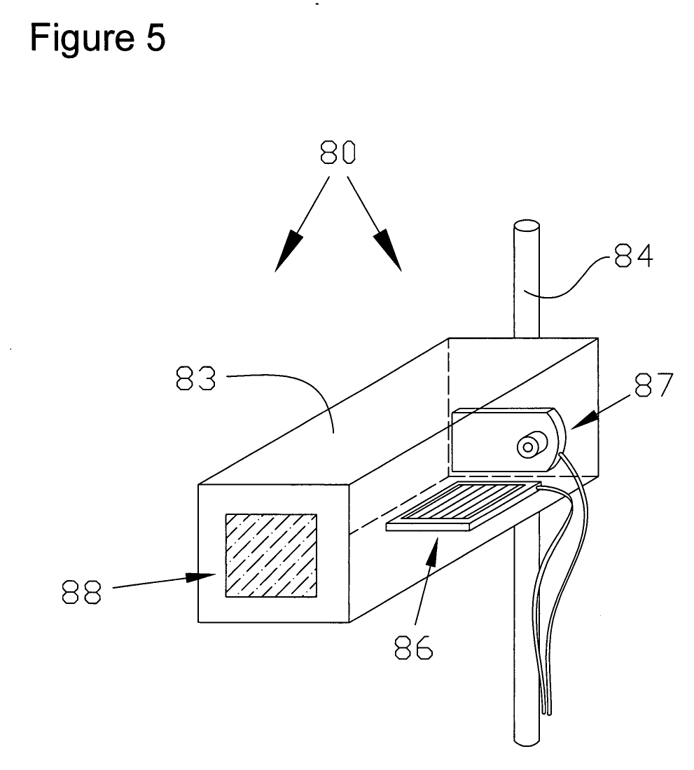

Turning to FIG. 5, the OCR scanner has a metal housing 83 secured to support 84. A light 86 within housing 83 is disposed between OCR scanner element 87 and the glass viewing pane 88.

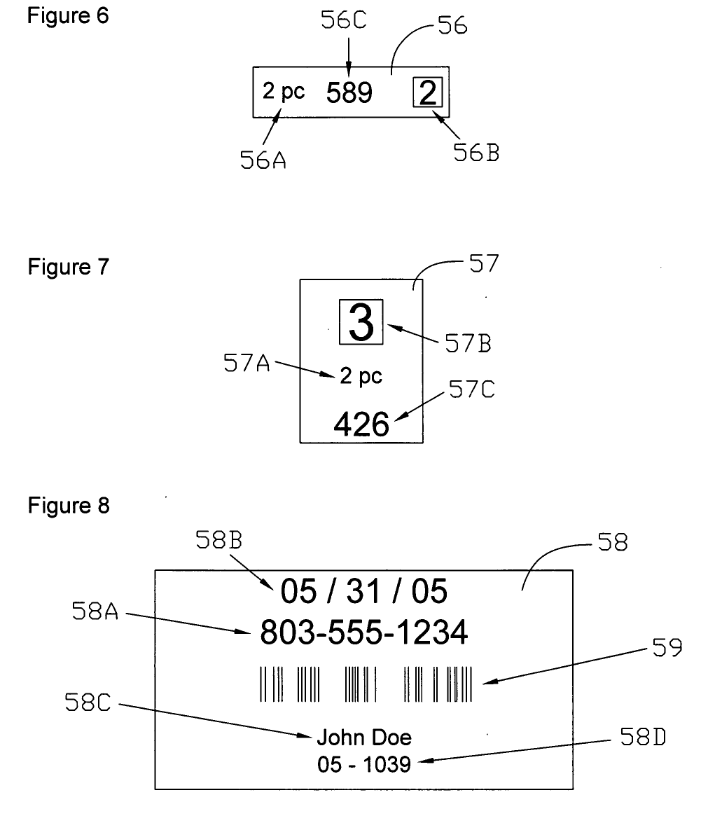

Representative garment tags are shown in FIGS. 6-8. There are industry “generic” tags that can be ordered from several drycleaning supply companies, and there are “customized” paper tags that are designed and printed to the drycleaner's specifications. All of these tags (generic or custom) are available in ten standard colors. Some drycleaners use the color of the tag to indicate which day of the week the clothes are promised to be ready for the customer to pick up. Some use colored tags to indicate which store the clothes originated from and will be returned to. All of the sample tags in FIGS. 6-8 can be produced in ten colors.

The indicia on each tag is read by the OCR scanner and is interpreted by the software program discussed hereinafter. The indicia information is displayed on the computer screen for the attendant to view and confirm before processing the garment. Therefore it is the responsibility of the attendant to verify that the indicia is correct. There is not an example of a striped tag, but any tag design can contain stripes, stars, diamonds, and other special characters to be used as additional identification marks, such as to distinguish “delivery route” Orders from “in store” orders, etc. The specific meaning varies from one drycleaner to another regarding the use of stripes, stars, diamonds, etc, as identifying marks on the tags.

In FIG. 6 a representative laundry tag 56 has a piece designation 56A that indicates that the order has two pieces for laundering, i.e., “2pc.” Both garments in this Order will have the same information printed on the paper tag 56. The Identification Control Number or customer order number 56C is “589.” A “promise number” 56B (i.e., “2”) that is in a box, indicates the day of the week that the order is “promised,” which is determined by a formula wherein 1=Monday, 2=Tuesday etc.

FIG. 7 shows a typical dry-cleaning tag 57 with piece identification 57A (i.e., 2 pieces in this order), a boxed “promise number” 57B (i.e., “3”) indicating that the completed order has been promised for Wednesday, and an identification control number or order number 57C (i.e., ″426).

FIG. 8 shows a more sophisticated custom dry cleaning tag 58 with a barcode 59. There is a customer phone number 58A (i.e., “803-555-1234”), an entry date 58B (i.e., “May 31, 2005”), and a customer name 58C (i.e., “John Doe”). The number 58D (i.e., “05-1039”) is a numerical representation of what is contained in the barcode 59 above it.

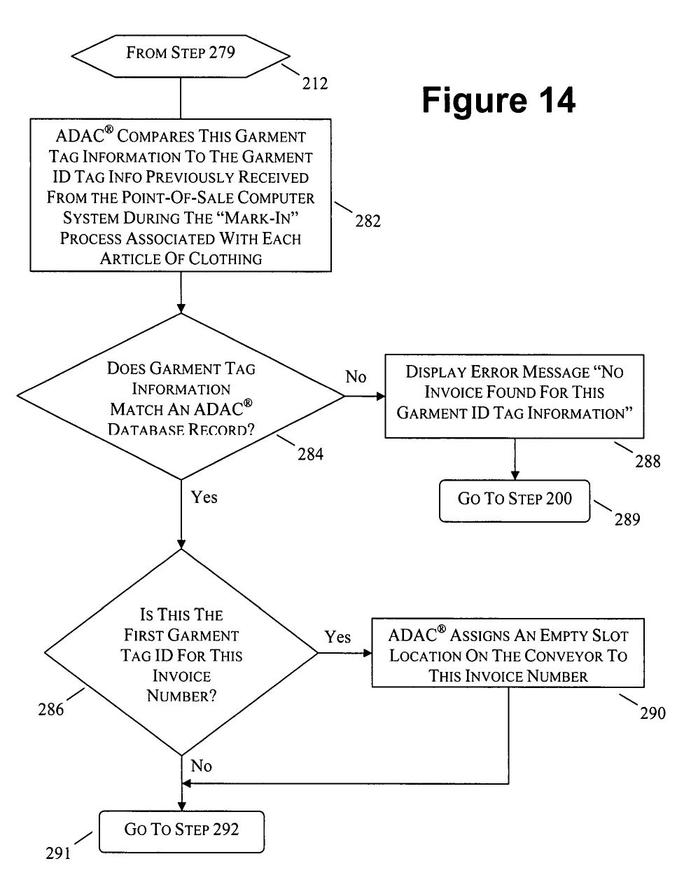

The software program commences at step 200 (FIG. 9). Step 202 determines if OCR scanning is being used, and if not, in step 204 the operator must use the scanner to read the bar code (i.e., such as barcode 59 in FIG. 8) or RF ID. The garment tag number is displayed on screen 65 (FIG. 1) in step 206. A decision is made in step 208 whether or not the screen information is correct. If so, the program jumps at 210 to step 212 in FIG. 14. If not, the operator manually enters correct data in step 211, entering missing information and correcting errors. When correct, the operator presses an “accept” button in step 213, which is followed by steps 210 (FIG. 9) and step 212 (FIG. 14), to be explained hereinafter.

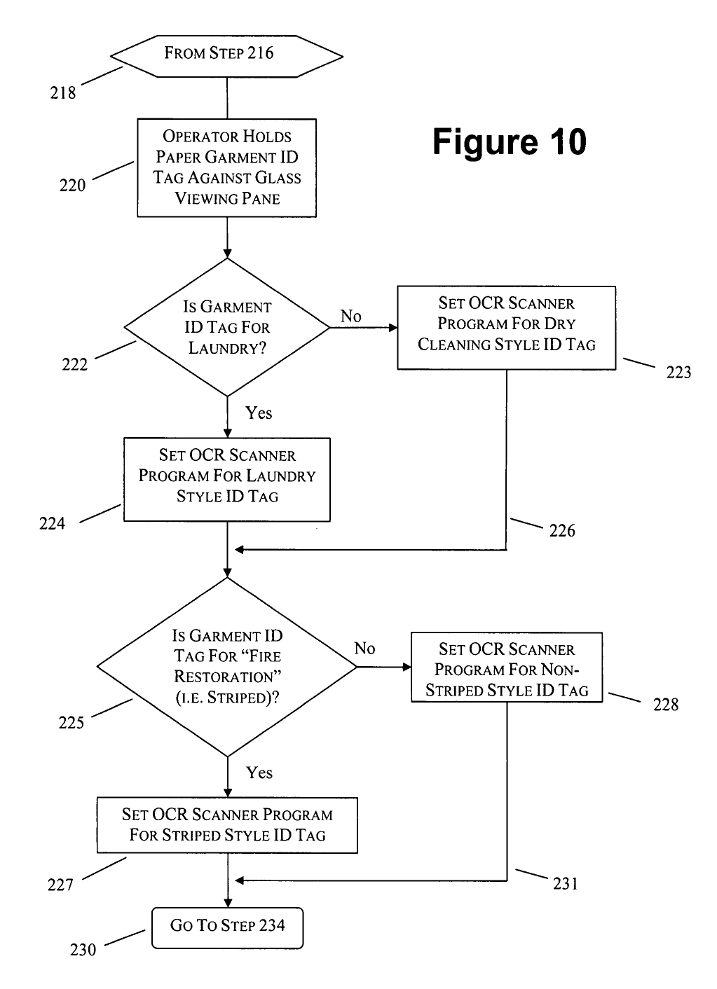

If step 202 (FIG. 9) determines that OCR reading is used, step 216 (FIG. 9) is followed by step 218 (FIG. 10). In step 220 (FIG. 10) the operator holds the ID tag against the glass viewing pane 88 (FIG. 5) of the OCR scanner. Step 222 determines if the garment ID tag is for laundry or dry-cleaning. If it is a laundry tag, the OCR is set for reading laundry style tags in step 224 and step 225 follows. If OCR determination step 222 determines that a dry cleaning tag exists, the OCR step 223 sets the scanner program for dry-cleaning and proceeds to step 225 as indicated by line 226.

Step 225 (FIG. 10) determines if the ID tag indicates fire restoration, i.e., the tag is striped, and if so, step 227 follows and the OCR scanner is set for striped style tags and proceeds to step 230. If not, a striped tag, step 228 sets the OCR scanner program for non-striped tags, and step 230 follows, as indicated by line 231.

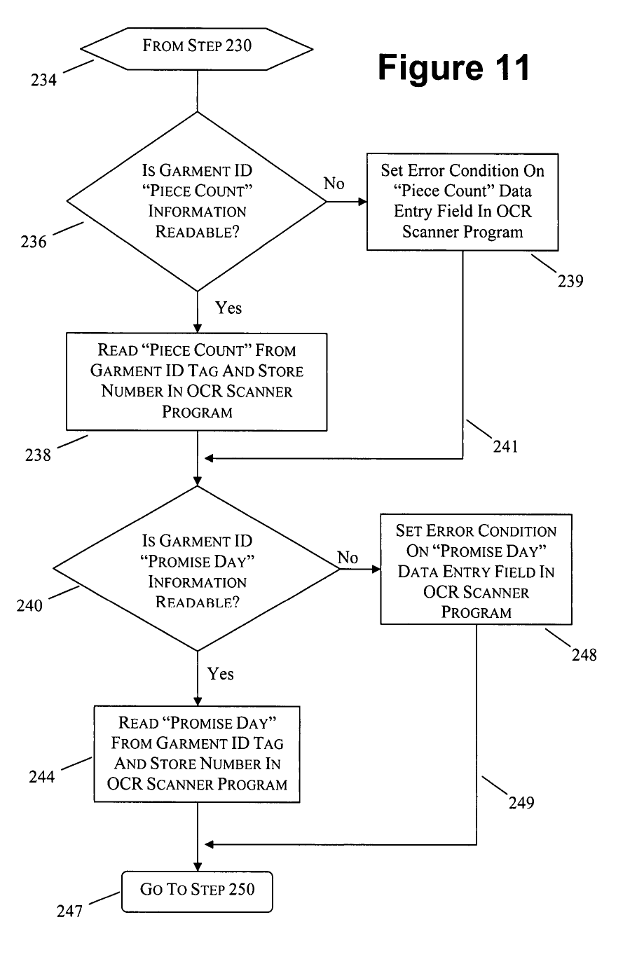

Step 230 (FIG. 10) connects to step 234 in FIG. 11 which is followed by step 236 that determines if the garment ID “piece count” is readable. If readable, the “piece count” is read and stored in the OCR scanner program in step 238. If the “piece count” is not readable in step 236, step 239 sets an error condition on the piece count data entry field in the OCR scanner program, and step 240 follows as indicated by line 241.

Step 240 (FIG. 11) determines if the “promised day” delivery date information is available. If so, step 244 reads the “promised date” from the garment ID tag and stored that date in the program, exiting to step 247. If not, step 248 sets an error condition for the “promised day” information in the data entry field of the OCR scanning program. Step 248 is followed by step 247 as indicated by line 249.

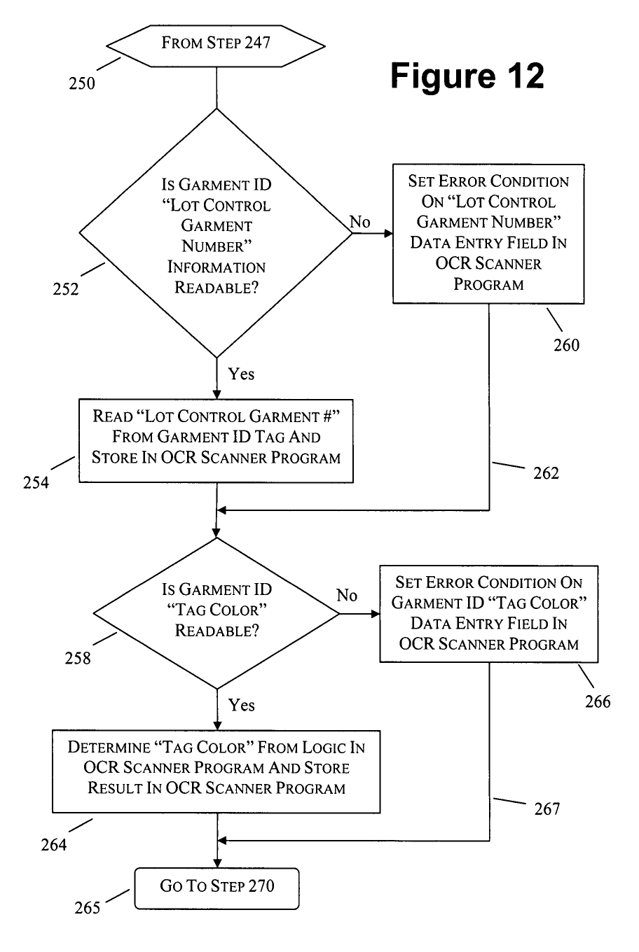

Step 247 (FIG. 11) connects with step 250 of FIG. 12, which is followed by step 252 that determines if the “lot control garment number” is readable. If it is, step 254 reads the “lot control garment” number and proceeds to step 258. If not, step 260 sets an error condition marker for the lot control garment number in the data entry field of the OCR scanner program, and continues to step 258 as indicated by line 262.

Step 258 (FIG. 12) determines if the garment ID “tag color” is readable. If so, step 264 determines the “tag color” in OCR logic, and stores the result in the OCR scanner program, then running to step 265. If “tag color” is not readable in step 258, step 266 sets an error condition for tag color in the data entry field of the OCR scanner program, and proceeds as indicated by line 267 to step 265.

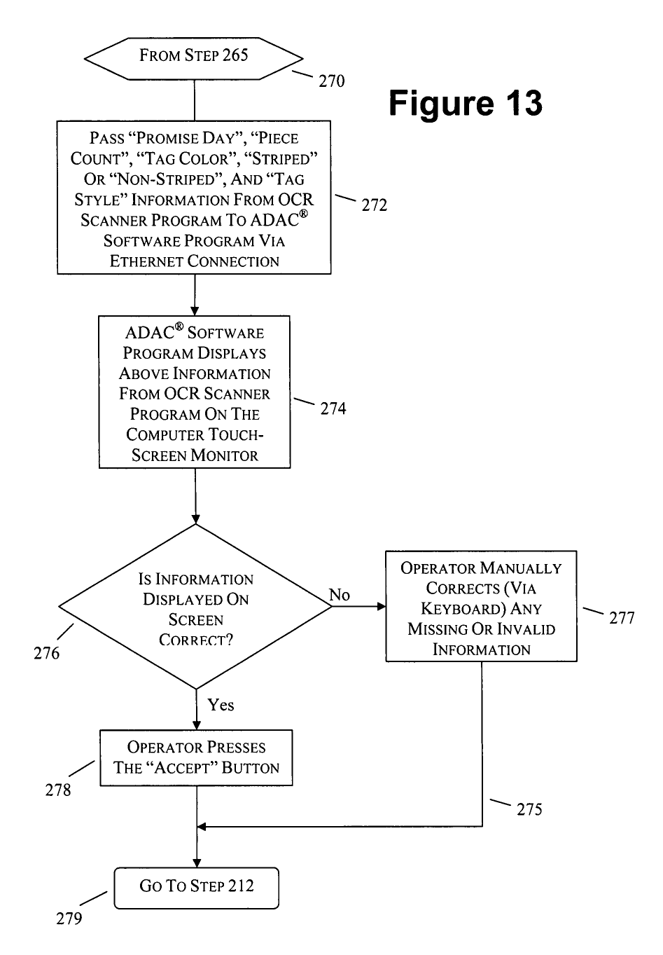

Step 265 (FIG. 12) connects to step 270 (FIG. 13) and thus to step 272, which has several functions. Step 272 passes previously collected tag status information relating to “promised day,” “piece count”, “tag color”, “striped or non-striped”, “tag style” to the software program. Step 274 displays the status information on the touch screen monitor 65 (FIG. 1). If decision step 276 (FIG. 13) finds the information correct, the operator then presses the “accept button” in step 278 and step 279 follows. If the displayed information in step 274 is not correct, the operator corrects missing or invalid information in step 277, which is then followed by step 278, as indicated by line 275.

Steps 210 (FIG. 9) and step 279 (FIG. 13) connect to step 212 at the top of FIG. 14 upon completion. Step 282 that follows compares the garment tag information against the garment ID tag information previously received at the walk in process form the point of sale, which was scanned and stored in the program. Step 284 determines if the garment tag information matches the previously established database record. If so, step 286 follows. If not, step 288 causes the screen display of an error message indicating that no invoice was found for this particular garment ID tag, and step 289 connects back to start step 200 (FIG. 9).

If the garment tag information matches, step 286 (FIG. 14) determines if this is the first garment tag ID for the invoice number. If so, step 290 assigns an empty slot location on the conveyor for the particular invoice number. Step 292 determines if this is the last garment tag ID for the particular invoice number, and, if not, step 294 follows. If this is the last garment ID for the particular order number, step 295 turns on a flashing light on the conveyor to indicate that this invoice or customer number is complete. Step 296 rotates the conveyor to a preassigned slot number location for this particular invoice number. In step 297 the operator removes these garments from the conveyor slot location, and a sensor acknowledges that the garments have been removed. Step 299 returns the program to beginning step 200 (FIG. 9).

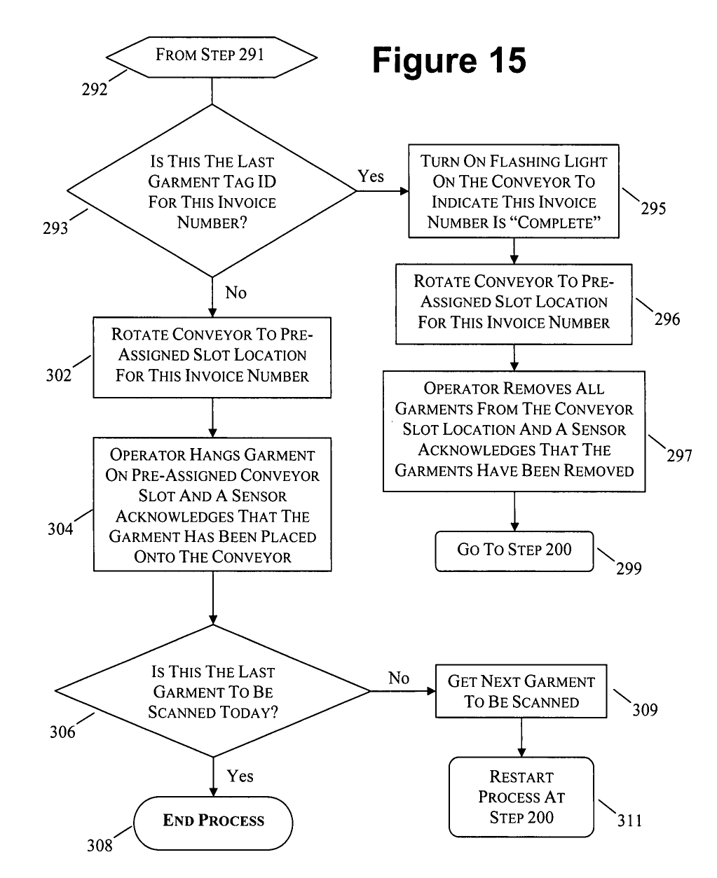

Step 294 (FIG. 14 ) connects with step 300 of FIG. 15, which is followed by step 302, that rotates the conveyor to a preassigned slot location for this invoice number. In the succeeding step 304 (FIG. 15) the operator hangs the garment on the preassigned conveyor slot and a sensor acknowledges that the garment has been placed there. If this is the last garment to be scanned today, as determined via step 306, the process is ended at 308. If this is not the last garment to be scanned, step 309 gets the next garment to be scanned, and box 311 indicates a repeat of the aforedescribed software process returning to box 200 (FIG. 9).

Referencing primarily FIG. 16, steps 400-407 operate independently to collect information from the Point-of-Sale System. The system continuously polls for existing information or uses the Operating Systems file notification service to determine when data is available. Step 400 starts the subroutine. If it is determined in Step 401 that the POS System has provided information by creating a file, the invention will read and parse the file in step 404 and check for errors in step 405. The information can be stored in the local database in a local table in step 406, or an error log entry is made in step 407 describing the error.

Steps 500 and 501 represent the method which the invention provides information to the Point-of-Sale System. Various events that the operator performs create data records to allow the Point-of-Sale System to have real-time status of the garments and orders. Examples of events are racking of a garment, un-racking of a garment, completion of an order and manual removal of an order among other events.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. An automated dry-cleaning inventory process adapted for use adjacent or within a: reception area of a dry-cleaning establishment for inventorying items such as garments to be cleaned, the process comprising the steps of:
(A) receiving and then uniquely marking one or more items from a given customer in a given transaction;
(B) determining a customer order group comprising all items received in the mark-in process of step (a);
(C) cleaning items from one or more groups;
(D) preassembling groups of cleaned items:
(E) recognizing item attributes through the steps of:
(i) scanning data from preassembled items
(ii) generating an internal binary text string from scanned data in said step (E)(i);
(iii) comparing the binary text strings from said step (e)(ii) to either various text strings stored in an inventory management system database, or to various text strings stored in an internal lookup table, to identify the group an item belongs to;
(iv) assigning a specific slot on an assembly conveyor for given groups;
(F) activating an assembly conveyor to position the assigned slot location on the conveyor adjacent a loading shroud;
(G) reassembling items into their original groups by placing items onto the reserved slot determined by the computer;
(H) once reassembly of a given group is completed, activating the conveyor to transfer a given group to an bagging station prior to customer delivery.

2. The dry-cleaning inventory process defined in claim 1 including the further step of printing a customer receipt after scanning the last item of a specific group, and listing specific information related to each item in the group.

3. The dry-cleaning inventory process defined in claim 1 including the further step of visually indicating to an operator that a customer order group is complete and ready to be removed from the assembly conveyor.

4. The dry-cleaning inventory process defined in claim 3 including the further step of printing generating an electronic signal when a customer order has been removed from the conveyor, and reassigning the given conveyor slot for another customer order.

5. An automated dry-cleaning inventory process adapted for use adjacent or within a reception area of a dry-cleaning establishment for inventorying items such as garments to be cleaned, the process comprising the steps of:
(A) receiving and then uniquely marking one or more items from a given customer in a given transaction;
(B) determining a customer order group comprising all items received in the mark-in process of step (a);
(C) cleaning items from one or more groups;
(D) preassembling groups of cleaned items:
(E) recognizing item attributes through the steps of:
(i) scanning data from preassembled items
(ii) generating an internal binary text string from scanned data in said step (E)(i);
(iii) comparing the binary text strings from said step (e)(ii) to either various text strings stored in an inventory management system database and continuously polling for existing information to determine if a point of sale system has provided information by creating a file and storing in a local database;
(iv) assigning a specific slot on an assembly conveyor for given groups;
(F) activating an assembly conveyor to position the assigned slot location on the conveyor adjacent a loading shroud;
(G) reassembling items into their original groups by placing items onto the reserved slot determined by the computer;
(H) once reassembly of a given group is completed, activating the conveyor to transfer a given group to an bagging station prior to customer delivery.

6. The dry-cleaning inventory process defined in claim 5 including the further step of printing a customer receipt after scanning the last item of a specific group, and listing specific information related to each item in the group.

7. The dry-cleaning inventory process defined in claim 5 including the further step of visually indicating to an operator that a customer order group is complete and ready to be removed from the assembly conveyor.

8. The dry-cleaning inventory process defined in claim 7 including the further step of printing generating an electronic signal when a customer order has been removed from the conveyor, and reassigning the given conveyor slot for another customer order.

9. The dry-cleaning inventory process defined in claim 8 including the further step of printing a customer receipt after scanning the last item of a specific group, and listing specific information related to each item in the group.

10. A computerized dry-cleaning inventory process for use adjacent or within a reception area of a dry-cleaning establishment for inventorying items such as garments to be cleaned, the process comprising the steps of:
(A) receiving and then uniquely marking one or more items from a given customer in a given transaction;
(B) determining a customer order group comprising all items received in the mark-in process of step (a);
(C) cleaning items from one or more groups;
(D) preassembling groups of cleaned items:
(E) recognizing item attributes including binary text strings through the steps of:
(i) determining if OCR scanning is being used, and if not, using the hand scanner to scan and if so, executing an OCR reading step;
(ii) hand scanning the tag on a given item to derive its information;
(iii) displaying the item tag number on screen;
(iv) determining whether the screen information is correct, and if incorrect, manually entering information to correct it;
(v) determines if the tag information matches the previously established database record;
(vi) if the tag information in said step (v) does not match a database record displaying an error message and returning to step (e);
(F) if the tag information from said step (v) does match a database record, determining if this is the first item for a given customer order group, and, if so, assigning an empty slot number on a conveyor to that order group;
(G) placing items from given customer order groups on matched slot numbers;
(H) determining if the tag information from said step (v) is the last item for said given customer order group, and if so, providing a warning to the operator to indicate that this group is complete, and if not, returning to said step (e)(ii);
(I) once reassembly of a given group is completed, activating the conveyor to transfer a given group to an bagging station prior to customer delivery.
(J) removing completed groups from their conveyor slot locations at said bagging station; and,
(K) providing a warning that the garments have been removed.

11. The computerized dry-cleaning inventory process as defined in claim 10 wherein said OCR reading step (E)(i) comprises the steps of:
(A) reading the item tag with an OCR scanner;
(B) determining if the tag is for laundry or dry-cleaning, and setting the OCR for reading either laundry or dry-cleaning tags;
(C) determining if the tag is striped or unstriped, and setting the OCR scanner for either striped or unstriped tags;
(D) determining if the tag “piece count” is readable, and if readable, storing the “piece count” in the OCR scanner program, and if not readable, setting an error condition on the piece count data entry field in the OCR scanner program;
(E) determining if the “promised day” delivery date information is available, and if available, reading and storing the “promised date” and if not, setting an error condition for the “promised day” information in the data entry field of the OCR scanning program;
(F) determining if the “lot control garment number” is readable, and if so, reading and storing the “lot control garment number” and if not, setting an error condition for the lot control garment number in the data entry field of the OCR scanner program; and, (G) determining if the garment ID “tag color” is readable, and if so reading and storing the “tag color” in OCR logic, and if “tag color” is not readable, setting an error condition for tag color in the data entry field of the OCR scanner program.

12. The computerized dry-cleaning inventory process as defined in claim 11 comprising the further steps of:
(A) displaying collected tag status information derived from steps 11(B)-11(G);
(B) determining if information displayed in step 12(A) is correct, and if not, correcting it
(C) comparing information derived from said step 10(A) to that derived in steps 12(A) and 12(B) and if not, displaying an error message; and,
(D) returning to said step 10(F).
